(19) United States
(12) Patent Application Publication
(10) Pub. No.: US 2025/0027809 A1
(43) Pub. Date: Jan. 23, 2025

(54) VIBRATION DETECTION DEVICE AND VIBRATION DETECTION METHOD

(71) Applicant: DARFON ELECTRONICS CORP., Taoyuan City (TW)

(72) Inventors: Hsin-Chi Chang, Taoyuan City (TW); Yang-Cheng Wu, Taoyuan City (TW); Chia-Hsiang Tung, Taoyuan City (TW)

(73) Assignee: DARFON ELECTRONICS CORP., Taoyuan City (TW)

(21) Appl. No.: 18/762,664

(22) Filed: Jul. 3, 2024

Related U.S. Application Data
(60) Provisional application No. 63/527,812, filed on Jul. 19, 2023.

(30) Foreign Application Priority Data
Dec. 26, 2023 (TW) 112150800

(51) Int. Cl. G01H 11/08; G01H 1/12; G06F 1/16

(52) U.S. Cl. CPC G01H 11/08; G01H 1/12; G06F 1/169

(57) ABSTRACT

A vibration detection device is used to execute a vibration detection method for detecting a vibrating touch pad. The vibration detection device includes a first detection module which has a first moving plate, a circuit board and a plurality of acceleration sensors. The first moving plate is movable relative to the vibrating touch pad. The circuit board is disposed on the first moving plate. The plurality of acceleration sensors is disposed on the circuit board as an array, and can abut against a plurality of measuring points on the vibrating touch pad when the first moving plate is moved close to the vibrating touch pad, so as to simultaneously detect a vibration feedback parameter generated from each of the plurality of acceleration sensors.

### CROSS REFERENCE TO RELATED APPLICATIONS

This application claims the benefit of U.S. Provisional Application No. 63/527,812, filed on Jul. 19, 2023. The content of the application is incorporated herein by reference.

### BACKGROUND OF THE INVENTION

### 1. Field of the Invention

The present invention relates to a vibration detection device and a vibration detection method, and more particularly, to a vibration detection device with a quick detection function and a related vibration detection method.

### 2. Description of the Prior Art

Conventional touch pad detection technology installs the sensors with the acceleration sensing function and the pressure sensing function on the robot arm. The robot arm must be moved to multiple positions on the touch pad in turn for acceleration and pressure sensing operation, which spends more detection time. In addition, the sensor with the pressure sensing function is installed directly on the front end of the robot arm; if the robot arm moves quickly from one position to another position on the touch pad, the vibration amplitude caused by motion of the robot arm may exceed the vibration amplitude of the touch pad, which causes the sensor with the acceleration sensing function to sense vibration that do not belong to the touch pad for getting worse detection result when the robot arm is moved close to the touch pad. If the conventional touch pad detection technology slowly moves the robot arm, the required detection period is further extended. Thus, design of a detection device of rapidly detecting parameters related to vibration and acceleration of the touch pad is an important issue in the related detection industry.

### SUMMARY OF THE INVENTION

The present invention provides a vibration detection device with a quick detection function and a related vibration detection method for solving above drawbacks.

According to the claimed invention, a vibration detection device is adapted to detect a vibrating touch pad. The vibration detection device includes a first detection module. The first detection module includes a first moving plate, a circuit board and a plurality of acceleration sensors. The first moving plate is movable relative to the vibrating touch pad. The circuit board is disposed on the first moving plate. The plurality of acceleration sensors is disposed on the circuit board as an array. The plurality of acceleration sensors respectively abuts against a plurality of measuring points on the vibrating touch pad when the first moving plate is moved close to the vibrating touch pad, so as to simultaneously detect a vibration feedback parameter generated from each of the plurality of measuring points. The vibration detection device further includes a second detection module. The second detection module includes a second moving plate and a pressure sensor. The pressure sensor is disposed on the second moving plate. The pressure sensor alternately abuts against each of the plurality of measuring points on the vibrating touch pad when the second moving plate is moved close to the vibrating touch pad, so as to acquire a force value provided by the pressure sensor in response to the vibration feedback parameter generated from each measuring point. The vibration detection device further includes a drive motor electrically connected to the first moving plate and the second moving plate.

According to the claimed invention, a vibration detection method is applied to a vibration detection device and adapted to detect a vibrating touch pad. The vibration detection method includes driving a plurality of acceleration sensors of the vibration detection device to respectively abutting against a plurality of measuring points on the vibrating touch pad, actuating a plurality of piezoelectric elements of the vibrating touch pad, detecting vibration feedback parameters generated from the plurality of measuring points by the plurality of acceleration sensors in a respective and simultaneous manner, and outputting the vibration feedback parameters of the plurality of measuring points on the vibrating touch pad. The vibration detection method further includes driving a pressure sensor of the vibration detection device that does not have the plurality of acceleration sensors to abut against a measuring point of the plurality of measuring points, increasing an external force applied to the measuring point by the pressure sensor until the plurality of piezoelectric elements is actuated so as to acquire a force value provided by the pressure sensor in response to the vibration feedback parameter generated from the measuring point, moving the pressure sensor to abut against another measuring point of the plurality of measuring points so as to acquire another force value provided by the pressure sensor in response to the vibration feedback parameter generated from the another measuring point, and outputting the force value and the another force value corresponding to the measuring points of the vibrating touch pad.

The vibration detection device and the vibration detection method of the present invention can design two detection modules respectively including the acceleration sensors and the pressure sensor, and the two detection modules can respectively abut against the vibrating touch pad to acquire the vibration feedback parameter. The present invention can abut the plurality of acceleration sensors against the plurality of measuring points on the vibrating touch pad simultaneously, so as to immediately acquire the vibration feedback parameters of all the measuring points in the specific vibration mode. The present invention can further utilize the verification platform that moves rapidly to adjust position of the vibrating touch pad relative to the vibration detection device, and use the pressure sensor with the high response frequency to alternately abut against the plurality of measuring points on the vibrating touch pad, so as to sequentially acquire the vibration feedback parameter of each measuring point in the specific vibration mode. Comparing to the prior art, the vibration detection device and the vibration detection method of the present invention can accurately and rapidly detect the vibration feedback parameters of all the measuring points on the vibrating touch pad, and therefore have preferred market competition.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an application diagram of a vibration detection device according to an embodiment of the present invention.

FIG. 2 is s structural diagram of a vibrating touch pad according to the embodiment of the present invention.

FIG. 3 is an appearance diagram of the vibrating touch pad according to the embodiment of the present invention.

FIG. 4 is a lateral view of a part of the vibration detection device according to the embodiment of the present invention.

FIG. 5 is a diagram of a part of the vibration detection device according to the embodiment of the present invention.

FIG. 6 is a diagram of the vibration detection device in another operation state according to the embodiment of the present invention.

FIG. 7 and FIG. 8 are flow charts of a vibration detection method in different states according to the embodiment of the present invention.

### DETAILED DESCRIPTION

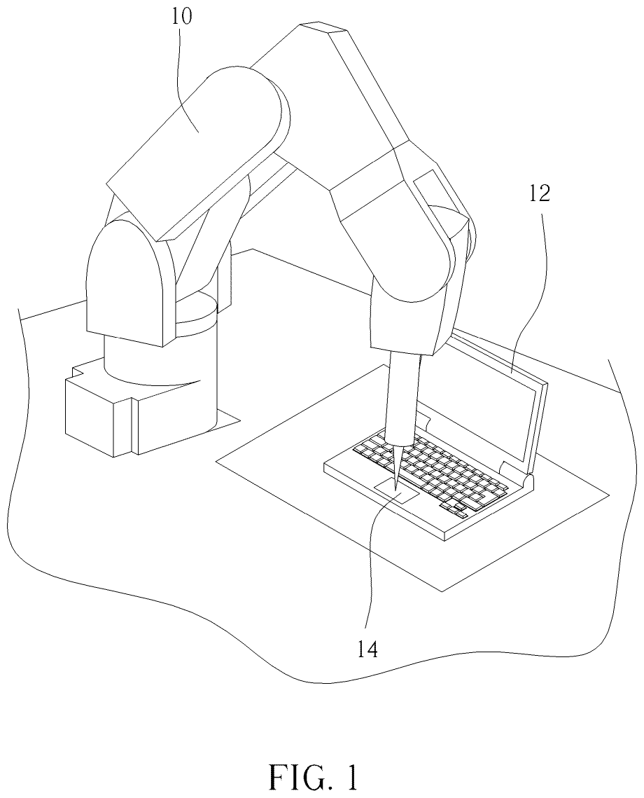

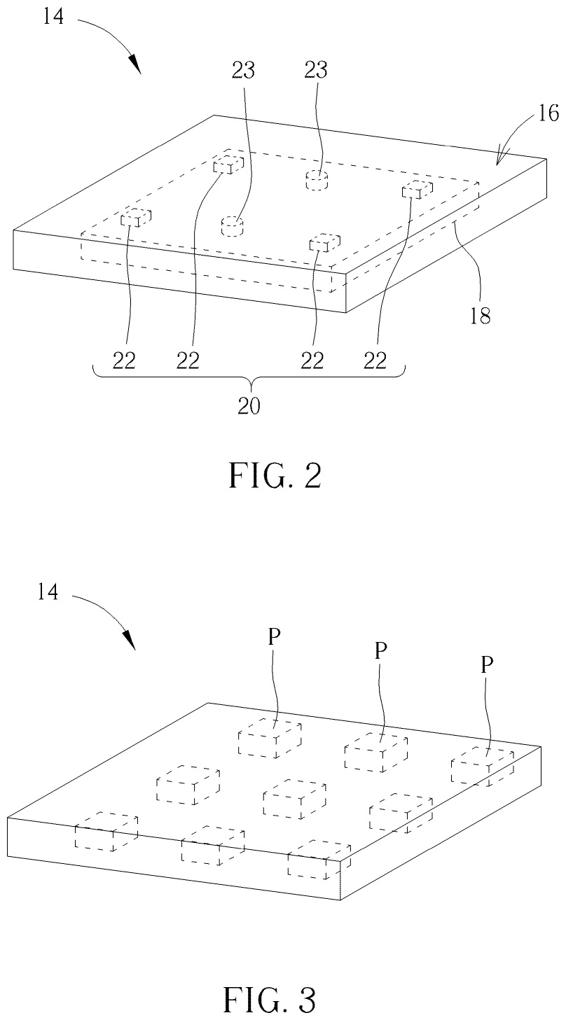

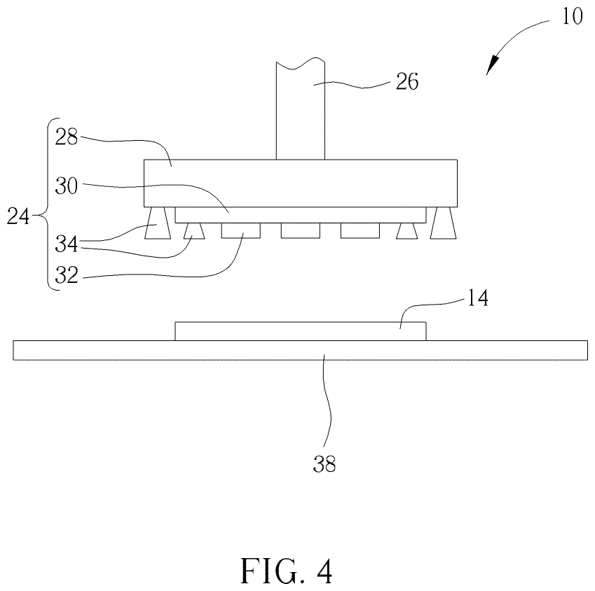

Please refer to FIG. 1 to FIG. 3. FIG. 1 is an application diagram of a vibration detection device 10 according to an embodiment of the present invention. FIG. 2 is s structural diagram of a vibrating touch pad 14 according to the embodiment of the present invention. FIG. 3 is an appearance diagram of the vibrating touch pad 14 according to the embodiment of the present invention. The vibration detection device 10 can be used to detect the vibrating touch pad 14 of a notebook 12. The vibrating touch pad 14 can at least include a touch surface 16, a position detection module 18 and a vibration module 20. The touch surface 16 can be an outer cover of the vibrating touch pad 14; a user can utilize an external object, such as a finger, a stylus, or a detection arm of the vibration detection device 10, to click or move on the touch surface 16. The touch surface 16 can be fixed to a case of the vibrating touch pad 14, and the touch surface 16 is not moved downwardly when the vibrating touch pad 14 is operated. The position detection module 18 can be disposed under the touch surface 16, and utilize capacitive sensors or other sensors to detect touching coordinates and a moving path of the external object on the touch surface 16.

The vibration module 20 can include a plurality of piezoelectric elements 22 distributed under different positions of the touch surface 16 and used to generate vibration feedback. The vibrating touch pad 14 can further include trigger units 23 distributed under different positions of the touch surface 16 and used to detect a force value of the external object. When the force value applied to the vibrating touch pad 14 by the external object exceeds a preset threshold, the trigger unit 23 can drive the vibration module 20 and the touch surface 16 to generate vibration through the piezoelectric elements 22; the vibration can provide various vibration feedback parameters, such as vibration amplitude, a vibration delay period and a vibration duration. Practical application of the vibration feedback parameters is not limited to the foresaid embodiment. The vibration amplitude can be interpreted as maximal oscillation displacement of the touch surface 16 driven by the piezoelectric elements 22. The vibration delay period can be interpreted as time difference between one point of time that the external object contacts the touch surface 16 and another point of time that vibration of the vibration module 20 exceeds preset amplitude. The vibration duration can be interpreted as time difference between one point of time that the vibration of the vibration module 20 exceeds the preset amplitude and another point of time that the vibration of the vibration module 20 is ended.

The present invention can set a plurality of measuring point P on the vibrating touch pad 14, and the plurality of measuring point P can be respectively distributed in different positions of the touch surface 16; as the embodiment shown in FIG. 3, the vibrating touch pad 14 can have nine measuring points P, and a number of a position of the measuring point P are not limited to the foresaid embodiment and depend on a design demand. Generally, a number of the piezoelectric element 22 can be smaller than a number of the measuring point P; however, practical application of foresaid number difference is not limited to the foresaid embodiment. Position of the piezoelectric element 22 distributed on the touch surface 16 can align with one measuring point P, or align with a gap between or among the measuring points P; position of the piezoelectric element 22 can depend on numbers and distribution of the measuring point P and the piezoelectric element 22. The vibration detection device 10 can simultaneously detect the vibration feedback parameters generated from the nine measuring points P on the vibrating touch pad 14 in all the vibration modes for quick detection.

In the preferred embodiment of the present invention, the vibration module 20 can utilize any combination of the plurality of piezoelectric elements 22 to provide multiple vibration modes, so as to simulate the vibration feedback of the vibrating touch pad 14 in some possible situations. For example, if the vibration module 20 has four piezoelectric elements 22, the vibration module 20 can provide a vibration mode of actuating one of the piezoelectric elements 22, a vibration mode of actuating any two of the piezoelectric elements 22, a vibration mode of actuating any three of the piezoelectric elements 22, and a vibration mode of actuating all the piezoelectric elements 22. The vibration detection device 10 can utilize all the acceleration sensors to detect the vibration feedback parameter generated from all the measuring points P on the vibrating touch pad 14 regardless of the vibration mode in which the vibrating touch pad 14 is actuated.

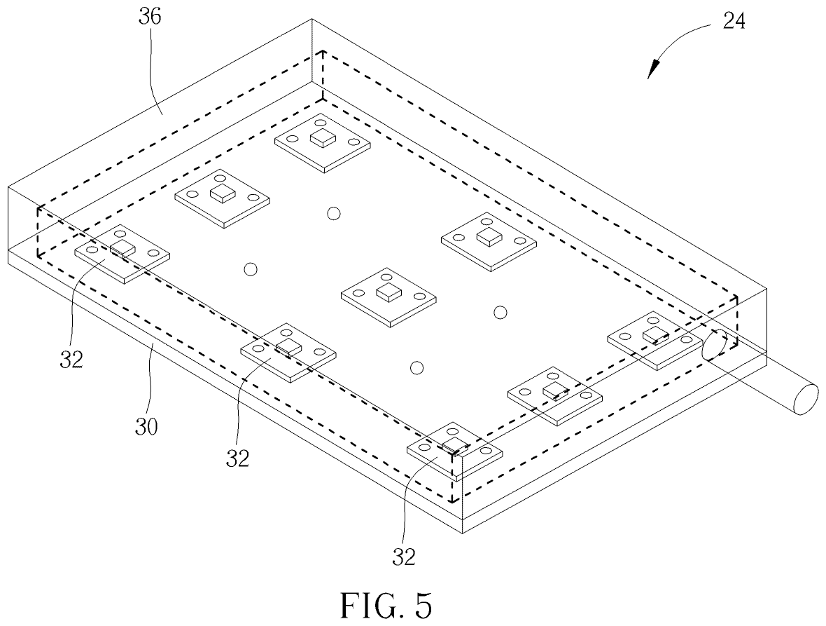

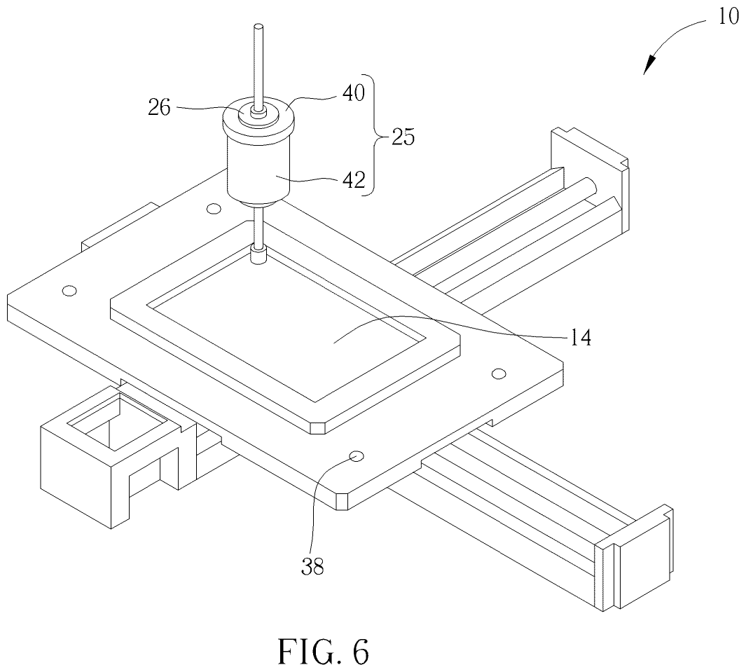

Please refer to FIG. 4 and FIG. 5. FIG. 4 is a lateral view of a part of the vibration detection device 10 according to the embodiment of the present invention. FIG. 5 is a diagram of a part of the vibration detection device 10 according to the embodiment of the present invention. The vibration detection device 10 can include a first detection module 24, a second detection module 25 and a drive motor 26. The drive motor 26 can be used to move the first detection module 24 and the second detection module 25 close to or away from the vibrating touch pad 14. The first detection module 24 can include a first moving plate 28, a circuit board 30, an acceleration sensor 32 and a positioning component 34. The first moving plate 28 can be driven by the drive motor 26 to move close to or away from the vibrating touch pad 14. The plurality of acceleration sensors 32 can be disposed on a surface of the circuit board 30 facing the vibrating touch pad 14 as an array in a coplanar manner. The acceleration sensors 32 can be covered by an outer shield 36, and sensing data of all the acceleration sensors 32 can be transmitted via the same signal transmission cable. A number of the acceleration sensor 32 can be the same as a number of the measuring point P, and a position of the acceleration sensor 32 can correspond to a position of the measuring point P. The circuit board 30 can be disposed on the first moving plate 28. The positioning component 34 can be disposed on the first moving plate 28.

Generally, the vibrating touch pad 14 can be put on a verification platform 38. When the first detection module 24 is driven by the drive motor 26 to move the first moving plate 28 close to the vibrating touch pad 14, the positioning component 34 can abut against the vibrating touch pad 14 or the verification platform 38, so as to constrain a movement of the plurality of acceleration sensors 32 relative to the vibrating touch pad 14, and to ensure the acceleration sensors 32 can stably contact the measuring point P or surrounding areas, and to simultaneously detect the vibration feedback parameters generated from all the measuring points P; the vibration amplitude, the vibration delay period and the vibration duration of each measuring point P on the vibrating touch pad 14 can be acquired accordingly. In the preferred embodiment of the present invention, the positioning component 34 can be a suction cup, an insertion pin or any element with a positioning function. The vibration detection device 10 can drive all the acceleration sensors 32 of the first detection module 24 to simultaneously contact all the relevant measuring points P on the vibrating touch pad 14 in a surface contact manner. The first detection module 24 can simultaneously detect the vibration feedback parameters generated from all the measuring points P of the touch surface 16 no matter how many piezoelectric elements 22 are actuated by the vibration module 20 to apply vibration for the touch surface 16.

In the present invention, when vibration detection device 10 drives the plurality of acceleration sensors 32 of the first detection module 24 to align with and contact the measuring points P on the vibrating touch pad 14, a control circuit (which is not shown in the figures) can be used to drive the vibration module 20 of the vibrating touch pad 14 to actuate the multiple vibration modes in accordance with a specific sequence, so as to simultaneously detect the vibration feedback parameters generated from all the measuring point P in all the vibration modes. Further, the vibration detection device 10 may drive the plurality of acceleration sensors 32 of the first detection module 24 to contact the measuring points P on the vibrating touch pad 14, and an external force applied to the measuring points P can conform to a degree of actuating the piezoelectric elements 22 of the vibrating touch pad 14, so that the control circuit is unnecessary and the vibration feedback parameters generated from all the measuring points P in each vibration mode can be simultaneously detected. Actuation of the vibration module 20 is not limited to the foresaid embodiment, and depends on the design demand.

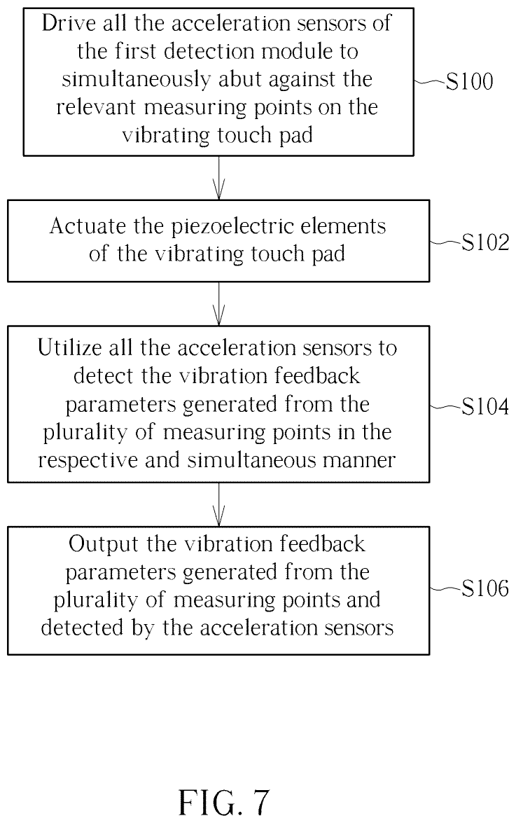

Please refer to FIG. 6. FIG. 6 is a diagram of the vibration detection device 10 in another operation state according to the embodiment of the present invention. The second detection module 25 of the vibration detection device 10 can have a pressure detection function and used to detect the force value of the external object applied for the vibrating touch pad 14. The first detection module 24 and the second detection module 25 can be alternately disposed on the detection arm (which can be the arm shown in FIG. 1) of the vibration detection device 10; the first detection module 24 may be removed from the detection arm, and then the second detection module 25 can be installed on the detection arm. Further, the vibration detection device 10 may have two detection arms, and the first detection module 24 and the second detection module 25 are respectively disposed on different detection arms and alternately applicable. The second detection module 25 can include a second moving plate 40 and a pressure sensor 42. The second moving plate 40 can be driven by the drive motor 26 to move close to or away from the vibrating touch pad 14. The pressure sensor 42 can be disposed on the second moving plate 40 via a circuit board (which is not shown in the figures).

As shown in FIG. 6, the vibrating touch pad 14 can be put on the verification platform 38 that can be moved in two axes; however, structural design of the verification platform 38 is not limited to the foresaid embodiment, and depends on the actual demand. The second moving plate 40 can be driven by the drive motor 26 to move close to the vibrating touch pad 14, and the pressure sensor 42 with high response frequency can alternately abut against the plurality of measuring points P on the vibrating touch pad 14 in accordance with rapid motion of the verification platform 38, so as to acquire the force value provided by the pressure sensor 42 in response to the vibration feedback parameter generated from the measuring point P. That is to say, the drive motor 26 can gradually increase the external force applied to any measuring point P by the pressure sensor 42 of the second detection module 25, and accumulated variation of the external force applied by the pressure sensor 42 can be defined as the force value when the piezoelectric elements 22 of the vibrating touch pad 14 are driven by the trigger unit 23 to generate vibration.

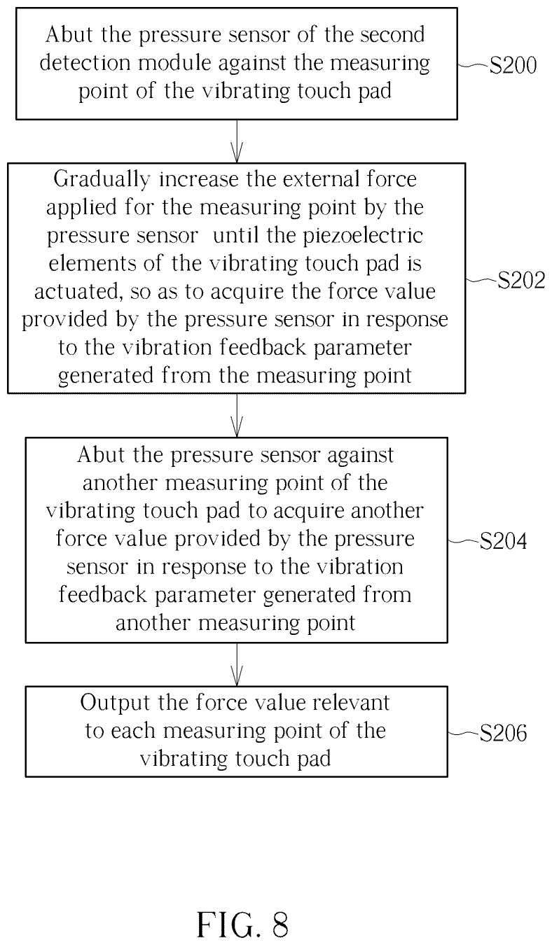

Please refer to FIG. 7 and FIG. 8. FIG. 7 and FIG. 8 are flow charts of a vibration detection method in different states according to the embodiment of the present invention. The vibration detection method illustrated in FIG. 7 and FIG. 8 can be suitable for the vibration detection device 10 shown in FIG. 1 to FIG. 6. First, step S100 can be executed to drive all the acceleration sensors 32 of the first detection module 24 of the vibration detection device 10 that does not have the second detection module 25 to simultaneously abut against the relevant measuring points P on the vibrating touch pad 14 by the drive motor 26. Then, step S102 can be executed to actuate the piezoelectric elements 22 of the vibrating touch pad 14 by the control circuit of the vibration detection device 10. An actuation period, an actuation number and position of the actuated piezoelectric element 22 can depend on the vibration mode of the vibrating touch pad 14. Then, step S104 can be executed to utilize all the acceleration sensors 32 to detect the vibration feedback parameters generated from the plurality of measuring points P in a respective and simultaneous manner. Final, step S106 can be executed that the vibration detection device 10 can output the vibration feedback parameters generated from the plurality of measuring points P and detected by the acceleration sensors 32 for further analysis.

Besides, step S200 can be executed to abut the pressure sensor 42 of the second detection module 25 of the vibration detection device 10 that does not have the first detection module 24 against the measuring point P of the vibrating touch pad 14. Then, step S202 can be executed to gradually increase the external force applied for the measuring point P by the pressure sensor 42 until the piezoelectric elements 22 of the vibrating touch pad 14 is actuated, so as to acquire the force value provided by the pressure sensor 42 in response to the vibration feedback parameter generated from the measuring point P. Then, step S204 can be executed to abut the pressure sensor 42 against another measuring point P of the vibrating touch pad 14 for acquiring another force value provided by the pressure sensor 42 in response to the vibration feedback parameter generated from another measuring point P. Final, step S206 can be executed that the vibration detection device 10 can output the force value relevant to each measuring point P of the vibrating touch pad 14 for further analysis when the force values of all the measuring point P are detected by the pressure sensor 42.

According to step S106 and step S200, the vibration detection method of the present invention can replace the first detection module 24 and the second detection module 25 of the vibration detection device 10 by each other for switching process. The vibration detection method of the present invention can remove the first detection module 24 from the detection arm, and then install the second detection module 25 on the detection arm; or, the vibration detection method of the present invention can dispose the first detection module 24 and the second detection module 25 on a rotation plate (which is not shown in the figures) of the detection arm, and the rotation plate can be rotated to switch one of the first detection module 24 and the second detection module 25 to proper position. The vibration detection method of the present invention may execute operation of the pressure sensor 42 (such as steps S200, S202, S204 and S206), and then execute operation of the acceleration sensor 32 (such as steps S100, S102, S104 and S106); the foresaid order can depend on the actual demand. Moreover, in step S100 and step S200, the positioning component 34 of the vibration detection device 10 can optionally abut against the verification platform 38 or the vibrating touch pad 14.

In conclusion, the vibration detection device and the vibration detection method of the present invention can design two detection modules respectively including the acceleration sensors and the pressure sensor, and the two detection modules can respectively abut against the vibrating touch pad to acquire the vibration feedback parameter. The present invention can abut the plurality of acceleration sensors against the plurality of measuring points on the vibrating touch pad simultaneously, so as to immediately acquire the vibration feedback parameters of all the measuring points in the specific vibration mode. The present invention can further utilize the verification platform that moves rapidly to adjust position of the vibrating touch pad relative to the vibration detection device, and use the pressure sensor with the high response frequency to alternately abut against the plurality of measuring points on the vibrating touch pad, so as to sequentially acquire the vibration feedback parameter of each measuring point in the specific vibration mode. Comparing to the prior art, the vibration detection device and the vibration detection method of the present invention can accurately and rapidly detect the vibration feedback parameters of all the measuring points on the vibrating touch pad, and therefore have preferred market competition.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A vibration detection device adapted to detect a vibrating touch pad, the vibration detection device comprising:
a first detection module comprising:
a first moving plate movable relative to the vibrating touch pad;
a circuit board disposed on the first moving plate; and
a plurality of acceleration sensors disposed on the circuit board as an array, the plurality of acceleration sensors respectively abutting against a plurality of measuring points on the vibrating touch pad when the first moving plate is moved close to the vibrating touch pad, so as to simultaneously detect a vibration feedback parameter generated from each of the plurality of measuring points.

2. The vibration detection device of claim 1, wherein the vibrating touch pad comprises a plurality of piezoelectric elements respectively aligning with the plurality of measuring points, or respectively aligning with space between the measuring points.

3. The vibration detection device of claim 1, wherein the plurality of acceleration sensors is disposed on a surface of the circuit board facing the vibrating touch pad in a coplanar manner.

4. The vibration detection device of claim 1, wherein the vibrating touch pad is put on a verification platform, the first detection module further comprises a positioning component disposed on the first moving plate and adapted to abut against the verification platform or the vibrating touch pad, so as to constrain a movement of the plurality of acceleration sensors relative to the vibrating touch pad.

5. The vibration detection device of claim 1, wherein the plurality of acceleration sensors detects the vibration feedback parameter to acquire vibration amplitude, a vibration delay period and/or a vibration duration of each measuring point on the vibrating touch pad.

6. The vibration detection device of claim 1, wherein the vibration detection device further comprises:
a second detection module comprising:
a second moving plate; and
a pressure sensor disposed on the second moving plate, the pressure sensor alternately abutting against each of the plurality of measuring points on the vibrating touch pad when the second moving plate is moved close to the vibrating touch pad, so as to acquire a force value provided by the pressure sensor in response to the vibration feedback parameter generated from each measuring point.

7. The vibration detection device of claim 6, wherein the force value is accumulated variation of an external force applied to the measuring point by the pressure sensor and gradually increased until the vibration feedback parameter is generated.

8. The vibration detection device of claim 6, wherein the vibration detection device further comprises a drive motor electrically connected to the first moving plate and the second moving plate.

9. The vibration detection device of claim 1, wherein the vibrating touch pad comprises a touch surface, a position detection module and a vibration module, the position detection module is disposed under the touch surface and adapted to detect a touch position and a moving path of an external object on the touch surface, and the vibration module generates the vibration feedback parameter when a force value applied to the vibrating touch pad by the external object exceeds a preset threshold.

10. The vibration detection device of claim 9, wherein a plurality of piezoelectric elements of the vibration module is distributed under different positions of the touch surface, and a number of the plurality of piezoelectric elements is smaller than a number of the plurality of measuring points.

11. The vibration detection device of claim 10, wherein the vibration module provides multiple vibration modes in accordance with the plurality of piezoelectric elements, and the first detection module detects the vibration feedback parameter of each measuring point in all the vibration modes.

12. A vibration detection method applied to a vibration detection device and adapted to detect a vibrating touch pad, the vibration detection method comprising:
driving a plurality of acceleration sensors of the vibration detection device to respectively abutting against a plurality of measuring points on the vibrating touch pad;
actuating a plurality of piezoelectric elements of the vibrating touch pad;
detecting vibration feedback parameters generated from the plurality of measuring points by the plurality of acceleration sensors in a respective and simultaneous manner; and
outputting the vibration feedback parameters of the plurality of measuring points on the vibrating touch pad.

13. The vibration detection method of claim 12, further comprising:
driving a pressure sensor of the vibration detection device that does not have the plurality of acceleration sensors to abut against a measuring point of the plurality of measuring points;
increasing an external force applied to the measuring point by the pressure sensor until the plurality of piezoelectric elements is actuated, so as to acquire a force value provided by the pressure sensor in response to the vibration feedback parameter generated from the measuring point;
moving the pressure sensor to abut against another measuring point of the plurality of measuring points, so as to acquire another force value provided by the pressure sensor in response to the vibration feedback parameter generated from the another measuring point; and
outputting the force value and the another force value corresponding to the measuring points of the vibrating touch pad.

14. The vibration detection method of claim 12, wherein the vibration detection method drives one set of the plurality of acceleration sensors and the pressure sensor, and then drives another set of the plurality of acceleration sensors and the pressure sensor.

15. The vibration detection method of claim 12, wherein the vibrating touch pad is put on a verification platform, the vibration detection method further comprises:
driving a positioning component of the vibration detection device to abut against the verification platform or the vibrating touch pad.

16. The vibration detection method of claim 12, further comprising:
removing the plurality of acceleration sensors from the vibration detection device and installing the pressure sensor on the vibration detection device.

17. The vibration detection method of claim 12, wherein the vibration feedback parameter is vibration amplitude, a vibration delay period and/or a vibration duration of each measuring point on the vibrating touch pad.

18. The vibration detection method of claim 12, wherein the force value is accumulated variation of an external force applied to the measuring point by the pressure sensor and gradually increased until the vibration feedback parameter is generated.

19. The vibration detection method of claim 12, wherein the vibrating touch pad comprises a touch surface, a position detection module and a vibration module, the position detection module is disposed under the touch surface and adapted to detect a touch position and a moving path of an external object on the touch surface, and the vibration module generates the vibration feedback parameter when a force value applied to the vibrating touch pad by the external object exceeds a preset threshold.

20. The vibration detection method of claim 19, wherein a plurality of piezoelectric elements of the vibration module is distributed under different positions of the touch surface, and a number of the plurality of piezoelectric elements is smaller than a number of the plurality of measuring points, the vibration module provides multiple vibration modes in accordance with the plurality of piezoelectric elements, the vibration detection method further comprises:
utilizing the plurality of acceleration sensors and the pressure sensor to detect the vibration feedback parameter of each measuring point in all the vibration modes.
